(19) United States
(12) Patent Application Publication
(10) Pub. No.: US 2023/0129450 A1
(43) Pub. Date: Apr. 27, 2023

(54) SWITCHING SYSTEM FOR EDR WATER PURIFIER WITH MULTIPLE SOLENOID VALVES

(71) Applicants: CHING-HSIUNG LIN, PINGTUNG CITY (TW); KEMFLO (NANJING) ENVIRONMENTAL TECHNOLOGY CO., LTD., NANJING (CN); KEMFLO INTERNATIONAL CO., LTD., PINGTUNG CITY (TW)

(72) Inventors: ALLEN DING, NANJING (CN); EDISON FAN, NANJING (CN)

(21) Appl. No.: 17/457,295

(22) Filed: Dec. 2, 2021

(30) Foreign Application Priority Data
Oct. 26, 2021 (CN) 202111249087.2

(51) Int. Cl. B01D 61/52; G05D 7/06; B01D 61/46; B01D 61/54; C02F 1/469

(52) U.S. Cl. CPC B01D 61/52; G05D 7/0652; B01D 61/46; B01D 61/54; C02F 1/4695; C02F 2201/005; B01D 2313/18

(57) ABSTRACT

A switching system has two inlet ends, two outlet ends, and an EDR membrane stack. Each inlet end and each outlet end are connected to both a primary branch and a secondary branch. Solenoid valves are mounted on each primary branch and each secondary branch to switch between opening and closing. The EDR membrane stack has two inlets, two outlets, and two electrodes. One inlet is connected to the primary branch of the two inlet ends while the other is connected to the secondary branch of the two inlet ends. One outlet is connected to the primary branch of the two outlet ends while the other is connected to the secondary branch of the two outlet ends. The polarity of the two electrodes is interchangeable to realize the reverse polarity of the electrodes. The two water flows that pass through the EDR membrane stack are interchangeable.

### BACKGROUND OF THE INVENTION

### 1. Field of the Invention

The present invention relates to a switching system for water purifiers, especially to a switching system for an electrodialysis reversal (EDR) water purifier with multiple solenoid valves.

### 2. Description of the Prior Arts

With the continuous improvement of life quality, most families install water purifiers to ensure healthful drinking water.

In a conventional water purifier, after a long-term running of the EDR membrane stack without reversing, the ions in the concentrated water chamber of the EDR membrane continuously accumulate and precipitate to form scale, which accelerates the degradation of the EDR membrane. Besides, since the first electrode is always positive and the second electrode is always negative, the service life of the EDR membrane stack and the second electrode will be shortened, which decreases the efficiency of the water purifier.

In response to this situation, the EDR membrane stack, the first electrode, and the second electrode need to be manually rinsed regularly to reduce the TDS (Total Dissolved Solids) in the EDR membrane stack. This solution not only wastes water but also wastes time and labor cost.

To overcome the shortcomings, the present invention provides a switching system for an EDR water purifier with multiple solenoid valves to mitigate or obviate the aforementioned problems.

### SUMMARY OF THE INVENTION

The main objective of the present invention is to provide a switching system that is capable of switching two water paths of the EDR membrane stack without changing the two water inlets and the two water outlets to achieve the switching of a water purification branch and a concentrated water branch. Besides, by adjusting the positive and negative connection of the electrodes, the electrodes of the EDR membrane stack can be interchanged to effectively alleviate the generation of scale on the surface of the membrane stack, thereby extending the service life of the EDR membrane stack and the electrodes and improving the water purification efficiency of the EDR membrane stack.

The switching system for an EDR water purifier with multiple solenoid valves has a first inlet end, a second inlet end, a first main inlet branch path, a first sub inlet branch path, a second main inlet branch path, a second sub inlet branch path, a first outlet end, a second outlet end, a first main outlet branch path, a first sub outlet branch path, a second main outlet branch path, a second sub outlet branch path, an EDR membrane stack, and multiple solenoid valves. The first main inlet branch path communicates with the first inlet end. The first sub inlet branch path communicates with the first inlet end. The second main inlet branch path communicates with the second inlet end. The second sub inlet branch path communicates with the second inlet end. The first main outlet branch path communicates with the first outlet end. The first sub outlet branch path communicates with the first outlet end. The second main outlet branch path communicates with the second outlet end. The second sub outlet branch path communicates with the second outlet end. The EDR membrane stack has a first inlet opening, a second inlet opening, a first outlet opening, a second outlet opening, a first electrode, and a second electrode. The first main inlet branch path and the second main inlet branch path are connected in parallel and then communicate with the first inlet opening. The first sub inlet branch path and the second sub inlet branch path are connected in parallel and then communicate with the second inlet opening. The first main outlet branch path and the second main outlet branch path are connected in parallel and then communicate with the first outlet opening. The first sub outlet branch path and the second sub outlet branch path are connected in parallel and then communicate with the second outlet opening. The first electrode and the second electrode are electrically connected to a positive electrode and a negative electrode respectively and interchangeably. The solenoid valves are respectively mounted on the first main inlet branch path, the first sub inlet branch path, the second main inlet branch path, the second sub inlet branch path, the first main outlet branch path, the first sub outlet branch path, the second main outlet branch path, and the second sub outlet branch path. Each of the solenoid valves is capable of opening and closing such that two water paths flowing through the EDR membrane stack can be interchanged.

By mounting solenoid valves on each of the inlet branch paths and outlet branch paths, the switching system can open some of the solenoid valves on particular inlet branch paths and particular outlet branch paths but close the others, so as to interchange the two water paths on two sides of the EDR membrane stack, which interchanges the clean water path and the high concentration water path. Additionally, by switching the electrical connections connected to the first electrode and the second electrode, which means adjusting the positive and negative energization of the electrodes, the electrodes of the EDR membrane stack can be interchanged.

The present invention adopts the switching system with multiple solenoid valves to effectively alleviate the generation of scale on the surface of the membrane stack, thereby extending the service life of the EDR membrane stack and the electrodes and improving the water purification efficiency of EDR membrane stack.

Other objectives, advantages and novel features of the invention will become more apparent from the following detailed description when taken in conjunction with the accompanying drawings.

### BRIEF DESCRIPTION OF THE DRAWINGS

FIG. 1 is a schematic diagram of a switching system for an EDR water purifier with multiple solenoid valves in accordance with the present invention;

FIG. 2 is a schematic diagram of the switching system in FIG. 1, showing the conventional operation mode; and

FIG. 3 is a schematic diagram of the switching system in FIG. 1, showing the reversal operation mode.

### DETAILED DESCRIPTION OF THE PREFERRED EMBODIMENTS

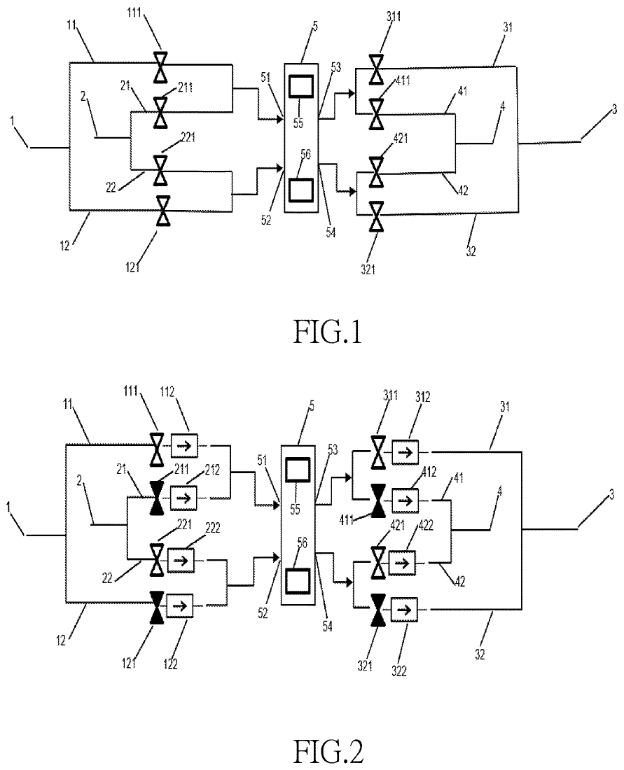

With reference to FIG. 1, a switching system for an EDR water purifier with multiple solenoid valves in accordance with the present invention comprises a first inlet end 1, a second inlet end 2, a first main inlet branch path 11, a first sub inlet branch path 12, a second main inlet branch path 21, a second sub inlet branch path 22, an EDR membrane stack 5, a first outlet end 3, a second outlet end 4, a first main outlet branch path 31, a first sub outlet branch path 32, a second main outlet branch path 41, and a second sub outlet branch path 42. The EDR membrane stack 5 has a first inlet opening 51, a second inlet opening 52, a first outlet opening 53, a second outlet opening 54, a first electrode 55, and a second electrode 56. The first inlet end 1 communicates with the first main inlet branch path 11 and the first sub inlet branch path 12. The second inlet end 2 communicates with the second main inlet branch path 21 and the second sub inlet branch path 22. The first outlet end 3 communicates with the first main outlet branch path 31 and the first sub outlet branch path 32. The second outlet end 4 communicates with the second main outlet branch path 41 and the second sub outlet branch path 42. The first main inlet branch path 11 and the second main inlet branch path 21 are connected in parallel and then communicate with the first inlet opening 51 of the EDR membrane stack 5. The first sub inlet branch path 12 and the second sub inlet branch path 22 are connected in parallel and then communicate with the second inlet opening 52 of the EDR membrane stack 5. The first main outlet branch path 31 and the second main outlet branch path 41 are connected in parallel and then communicate with the first outlet opening 53 of the EDR membrane stack 5. The first sub outlet branch path 32 and the second sub outlet branch path 42 are connected in parallel and then communicate with the second outlet opening 54 of the EDR membrane stack 5. Multiple solenoid valves are respectively mounted on the first main inlet branch path 11, the first sub inlet branch path 12, the second main inlet branch path 21, the second sub inlet branch path 22, the first main outlet branch path 31, the first sub outlet branch path 32, the second main outlet branch path 41, and the second sub outlet branch path 42. In other words, each of the inlet branch paths and each of the outlet branch paths are implemented with a respective solenoid valve. Each of the solenoid valves is capable of opening and closing such that two water paths flowing through the EDR membrane stack can be interchanged. The first electrode 55 and the second electrode 56 are electrically connected to a positive electrode and a negative electrode respectively and interchangeably. By adjusting the positive and negative energization of the first electrode 55 and the second electrode 56, the polarity of the first electrode 55 and the polarity of the second electrode 56 are reversed.

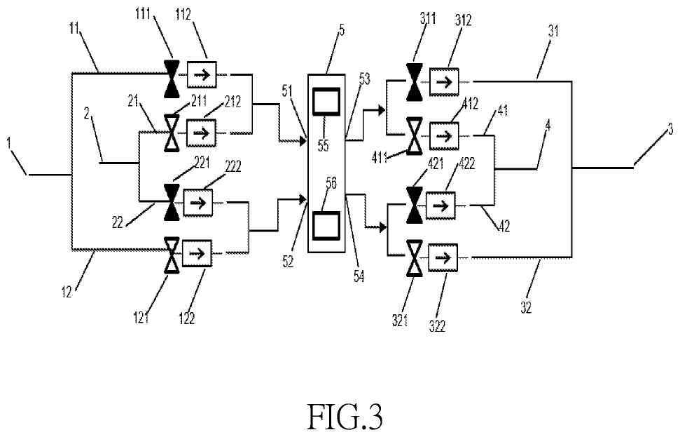

With reference to FIGS. 2 and 3, the switching system can also be implemented with multiple check valves mounted on the first main inlet branch path 11, the first sub inlet branch path 12, the second main inlet branch path 21, the second sub inlet branch path 22, the first main outlet branch path 31, the first sub outlet branch path 32, the second main outlet branch path 41 and the second sub outlet branch path 42. In a flowing direction of water, each of the check valves is disposed subsequent to the corresponding solenoid valve in order.

A preferred embodiment is described as follows.

With reference to FIG. 2, when the switching system is in the conventional operation mode, the first electrode 55 is connected to the positive electrode, the second electrode 56 is connected to the negative electrode. The solenoid valve 111 and the check valve 112 mounted on the first main inlet branch path 11, the solenoid valve 221 and the check valve 222 mounted on the second sub inlet branch path 22, the solenoid valve 311 and the check valve 312 mounted on the first main outlet branch path 31, and the solenoid valve 421 and the check valve 422 mounted on the second sub outlet branch path 42 are open. The solenoid valve 121 and the check valve 122 mounted on the first sub inlet branch path 12, the solenoid valve 211 and the check valve 212 mounted on the second main inlet branch path 21, the solenoid valve 321 and the check valve 322 mounted on the first sub outlet branch path 32, and the solenoid valve 411 and the check valve 412 mounted on the second main outlet branch path 41 are closed. Thus, water enters from the first inlet end 1, flows into the first inlet opening 51 of the EDR membrane stack 5 via the first main inlet branch path 11, flows through the first outlet opening 53 and the first main outlet branch path 31 after passing through the EDR membrane stack 5, and then flows out via the first outlet end 3. Besides, water enters from the second inlet end 2, flows into the second inlet opening 52 of the EDR membrane stack 5 via the second sub inlet branch path 22, flows through the second outlet opening 54 and the second sub outlet branch path 42 after passing through the EDR membrane stack 5, and then flows out via the second outlet end 4.

With reference to FIG. 3, when the switching system is in the reversal operation mode, the solenoid valve 121 and the check valve 122 mounted on the first sub inlet branch path 12, the solenoid valve 211 and the check valve 212 mounted on the second main inlet branch path 21, the solenoid valve 321 and the check valve 322 mounted on the first sub outlet branch path 32, and the solenoid valve 411 and the check valve 412 mounted on the second main outlet branch path 41 are open. The solenoid valve 111 and the check valve 112 mounted on the first main inlet branch path 11, the solenoid valve 221 and the check valve 222 mounted on the second sub inlet branch path 22, the solenoid valve 311 and the check valve 312 mounted on the first main outlet branch path 31, and the solenoid valve 421 and the check valve 422 mounted on the second sub outlet branch path 42 are closed. The first electrode 55 is connected to the negative electrode, and the second electrode 56 is connected to the positive electrode. Thus, water enters from the first inlet end 1, flows into the second inlet opening 52 of the EDR membrane stack 5 via the first sub inlet branch path 12, flows through the second outlet opening 54 and the first sub outlet branch path 32 after passing through the EDR membrane stack 5, and then flows out via the first outlet end 3. Besides, water enters from the second inlet end 2, flows into the first inlet opening 51 of the EDR membrane stack 5 via the second main inlet branch path 21, flows through the first outlet opening 53 and the second main outlet branch path 41 after passing through the EDR membrane stack 5, and then flows out via the second outlet end 4.

According to the above, by switching the flow direction of the water path between the conventional operation mode and the reversal operation mode, the two water paths on both sides of the EDR membrane stack are switched, thereby achieving the interchange of the clean water path and the high concentration water path. Further, by switching the electrodes connected to the first electrode 55 and the second electrode 56, the polarity of the electrodes of the EDR membrane stack can be reversed. Thus, the present invention effectively alleviates the generation of scale on the surface of the membrane stack, thereby extending the service life of the EDR membrane stack and the electrodes and improving the water purification efficiency of the EDR membrane stack.

Besides, the switching system has an electric control device (not shown in the drawings). The electric control device is capable of controlling opening and closing of each of the solenoid valves and switching the electrodes. Therefore, after the EDR membrane stack has run for a period of time, the electric control device can close some of the solenoid valves and opens the others and interchange the electrodes to switch between the conventional operation mode and the reversal operation mode.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A switching system for an electrodialysis reversal (EDR) water purifier with multiple solenoid valves, the switching system comprising:
a first inlet end;
a second inlet end;
a first main inlet branch path communicating with the first inlet end;
a first sub inlet branch path communicating with the first inlet end;
a second main inlet branch path communicating with the second inlet end;
a second sub inlet branch path communicating with the second inlet end;
a first outlet end;
a second outlet end;
a first main outlet branch path communicating with the first outlet end;
a first sub outlet branch path communicating with the first outlet end;
a second main outlet branch path communicating with the second outlet end;
a second sub outlet branch path communicating with the second outlet end;
an EDR membrane stack having
a first inlet opening; the first main inlet branch path and the second main inlet branch path connected in parallel and then communicating with the first inlet opening;
a second inlet opening; the first sub inlet branch path and the second sub inlet branch path connected in parallel and then communicating with the second inlet opening;
a first outlet opening; the first main outlet branch path and the second main outlet branch path connected in parallel and then communicating with the first outlet opening;
a second outlet opening; the first sub outlet branch path and the second sub outlet branch path connected in parallel and then communicating with the second outlet opening;
a first electrode; and
a second electrode; the first electrode and the second electrode electrically connected to a positive electrode and a negative electrode respectively and interchangeably; and
multiple solenoid valves respectively mounted on the first main inlet branch path, the first sub inlet branch path, the second main inlet branch path, the second sub inlet branch path, the first main outlet branch path, the first sub outlet branch path, the second main outlet branch path, and the second sub outlet branch path; each of the solenoid valves being capable of opening and closing such that two water paths flowing through the EDR membrane stack are interchangeable.

2. The switching system as claimed in claim 1, wherein
the switching system has a conventional operation mode and a reversal operation mode;
when the switching system is in the conventional operation mode, the solenoid valves mounted on the first main inlet branch path, the second sub inlet branch path, the first main outlet branch path, and the second sub outlet branch path are open, and the solenoid valves mounted on the first sub inlet branch path, the second main inlet branch path, the second main outlet branch path, and the first sub outlet branch path are closed;
when the switching system is in the reversal operation mode, the solenoid valves mounted on the first sub inlet branch path, the second main inlet branch path, the second main outlet branch path, and the first sub outlet branch path are open, and the solenoid valves mounted on the first main inlet branch path, the second sub inlet branch path, the first main outlet branch path, and the second sub outlet branch path are closed; and
when the switching system switches between the conventional operation mode and the reversal operation mode, the positive electrode and the negative electrode that are respectively connected to the first electrode and the second electrode are interchanged.

3. The switching system as claimed in claim 1, wherein the switching system has
an electric control device being capable of controlling each of the solenoid valves to open or close, and being capable of controlling the positive electrode and the negative electrode that are respectively connected to the first electrode and the second electrode to interchange.

4. The switching system as claimed in claim 2, wherein the switching system has
an electric control device being capable of controlling each of the solenoid valves to open or close, and being capable of controlling the positive electrode and the negative electrode that are respectively connected to the first electrode and the second electrode to interchange.

5. The switching system as claimed in claim 1, further comprising:
multiple check valves mounted on the first main inlet branch path, the first sub inlet branch path, the second main inlet branch path, the second sub inlet branch path, the first main outlet branch path, the first sub outlet branch path, the second main outlet branch path, and the second sub outlet branch path; in a flowing direction of water, each of the check valves disposed subsequent to the corresponding solenoid valve in order.

6. The switching system as claimed in claim 4, further comprising:
multiple check valves mounted on the first main inlet branch path, the first sub inlet branch path, the second main inlet branch path, the second sub inlet branch path, the first main outlet branch path, the first sub outlet branch path, the second main outlet branch path, and the second sub outlet branch path; in a flowing direction of water, each of the check valves disposed subsequent to the corresponding solenoid valve in order.
